(19) United States
(12) Patent Application Publication
(10) Pub. No.: US 2019/0299412 A1
(43) Pub. Date: Oct. 3, 2019

(54) Augmented Reality System

(71) Applicant: SICK AG, Waldkirch (DE)

(72) Inventors: Felix SCHWER, Waldkirch (DE); Frank HABERSTROH, Waldkirch (DE)

(21) Appl. No.: 16/281,462

(22) Filed: Feb. 21, 2019

(30) Foreign Application Priority Data
Mar. 29, 2018 (EP) 18165105.0

(51) Int. Cl. B25J 9/16; G06T 19/00; G06F 3/01; G06T 7/70; B25J 19/06; G08B 21/02

(52) U.S. Cl. CPC B25J 9/1676; G06T 19/006; G06F 3/011; G06F 2203/012; B25J 19/06; G08B 21/02; G06T 7/70

(57) ABSTRACT

An augmented reality device for overlapping an augmented reality with a real environment is provided to enable a high degree of freedom of movement of a person in an operation. The device includes a detection unit which detects the real environment and provides it as environmental data. At least one monitoring unit and at least one working unit are arranged in the environment. A communication unit receives safety data from the monitoring unit and process data from the working unit. A control unit processes the environmental data, the safety data and the process data. A current working area of the monitoring unit and a current position (aP) of the working unit are creatable as a current mapping of the real environment on the basis of the environmental and safety data. A future working area of the monitoring unit and a future position (zP) of the working unit are creatable.

The invention relates to an augmented reality system for overlapping an augmented reality with a real environment. In the following, the augmented reality system is also referred to as the AR system.

The AR system is used in a wide variety of applications. In today's industry, for example, the AR system is used to provide a user with a mapping of the real environment together with an extended reality map, so that the user can easily detect a possible deviation between the real map and the extended reality map. From this, a user using the AR system can extract a wide variety of information and take appropriate steps.

For example, the AR system captures a complex real circuit of a control cabinet as a real environment and overlaps the mapping of the real circuit with a calculated virtual circuit of the control cabinet as an extended reality mapping. From the overlap, the user can see a faulty wiring or an improved wiring as the deviation between the real and virtual wiring, so that the user can correct the faulty wiring or link the improved wiring on the basis of the displayed deviation.

The AR system thus enables the user to perceive a static real environment with augmented reality and to change the real environment if necessary.

It is an objective of the invention to improve an augmented reality system or AR system for the overlapping of a virtual reality with a real environment in such a way that a high degree of freedom of movement of a person can be achieved in an operation with the AR system.

The objective is solved according to the invention by an augmented reality system for overlapping an augmented reality with a real environment, comprising a detection unit which detects the real environment and provides it as environmental data, wherein at least one monitoring unit and at least one working unit are arranged in the environment, a communication unit which receives safety data from the monitoring unit and process data from the working unit, a control unit which processes the environmental data, the safety data and the process data, wherein a current working area of the monitoring unit and a current position of the working unit are creatable as a current mapping of the real environment on the basis of the environmental and safety data, and wherein a future working area of the monitoring unit and a future position of the working unit are creatable as a virtual mapping on the basis of the safety and process data at a preferably selectable future point in time, and a display unit which displays to a user the current mapping and the virtual mapping in relation to one another, wherein an image of the user at a current point in time of the creation of the current mapping is represented in the overlapping current and virtual mapping.

This has the advantage that the user receives in advance the necessary information where he will be in relation to the future real environment, so that he can see and avoid a possible collision with the working area of the monitoring unit or with the working unit.

According to a preferred embodiment, the augmented reality system includes a pair of glasses, a helmet display or an electronic communication device, in particular a smartphone or touchpad, so that the user can use the augmented reality system easily and handy. It is advantageous that several augmented reality systems can be networked with each other, so that several users with their respective augmented reality systems can walk through an environment simultaneously, whereby all users are displayed in the augmented reality systems. It is advantageous to integrate the control unit into the glasses, the helmet display or the electronic communication device. Preferably, the control unit can be arranged as a separate computer unit that calculates the overlap of the current and virtual mapping and transmits it to the display unit. In other words, the control unit advantageously includes a CPU.

According to another preferred embodiment, the detection unit comprises a camera, which in particular detects a room depth, and/or wide-angle camera. Advantageously, the monitoring unit comprises a monitoring camera, in particular a room depth detecting monitoring camera, a scanner, a light grid or a light barrier. This gives the user the advantage that the working area, in particular a shelter and a monitoring area, is displayed to the monitoring unit and this working area can be bypassed or avoided. This enables a higher availability of the working unit, as the user can avoid an unintentional slowing down or even shut down of the working unit by bypassing or avoiding the working area of the monitoring unit. As an alternative to a camera, the user's position can be determined using geolocation data (GPS) or indoor GPS and transmitted to the control unit. For this purpose, the augmented reality system preferably comprises a corresponding GPS transmitter-receiver unit.

Furthermore, according to a preferred embodiment, the working unit comprises a robot, a driverless transport system or a processing machine.

According to another preferred embodiment, the future point in time lies in several seconds in the future after the current working area of the monitoring unit has moved into a future position of the working area of the monitoring unit, if the working area of the monitoring unit is changeable with a movement of the working unit. This has the advantage that the increased availability of an operation of the working unit can be achieved, since the user can actively avoid triggering a safety alarm by the monitoring unit by avoiding or avoiding a collision with the working area of the monitoring unit.

Advantageously, the current position of the working unit has moved to the future position of the working unit in the seconds based on the process data, so that the user can see the future position of the working unit after these seconds and avoid or avoid it if necessary. By selecting the future point in time between the current safety and process data and the future safety and process data to be used for creating the virtual mapping, the user can set a sufficient and safe reaction time for himself, so that a danger of a collision can be completely excluded or sufficiently minimized.

According to another preferred embodiment, the future working range of the monitoring unit and the future position of the working unit are calculated by the control unit or are transmitted from the monitoring unit and the control unit of the working unit to the control unit of the augmented reality system. It is advantageous to transmit the safety data of the monitoring unit and the process data of the working unit to the communication unit of the augmented reality system by radio. In this context, the communication unit comprises a sender and a receiver to send and receive the process data.

According to another preferred embodiment, the future working area of the monitoring unit will reflect a visual direction of the monitoring unit. From this, the user can, for example, see a correct configuration of the monitoring unit for the working unit, since if the visual direction of the monitoring unit does not correspond to a direction of movement of the working unit, the configuration would be incorrect. In particular, when a movement of the working unit is coordinated with a movement of the monitoring unit, so that the monitoring unit rushes synchronously forward to the movement of the working unit in order to check a trajectory of the working unit.

According to another preferred embodiment, an avoidance direction or avoidance route is calculable and displayable for the user to avoid a collision with the future position of the working unit. Thus, the augmented reality system actively helps the user to avoid a collision with the working unit. Advantageously, the avoidance direction indicates a position or the avoidance route leads to a position which is outside the working range of the monitoring unit and/or the working area of the monitoring unit, which avoids unnecessary shut down of the working unit by the monitoring unit if the user avoids the collision with the work unit.

According to another preferred embodiment, the safety data of the monitoring unit include geometric data of the working area of the monitoring unit and the process data of the working unit motion data of the working unit. In particular, the working area of the monitoring unit is divided into a protective area and a monitoring area, whereby detection of an impermissible object within the protective area triggers a security reaction of the monitoring unit and the monitoring area represents an entire visible area of the monitoring unit. If an impermissible object is detected within the monitoring area, only a warning reaction of the monitoring unit would take place. This could slow down the working unit, but not shut it down.

According to another preferred execution example, a transition of the working unit from the current position to the future position is presentable to the user on the display unit as a visual sequence of a movement of the working unit on the basis of the process data. This has the advantage that the user not only recognizes the current and future position of the working unit, but also sees a trajectory of the working unit between these two positions. Advantageously, the visual sequence can be in the form of, preferably semi-transparent, images of the working unit or in the form of a schematic tube.

The system according to the invention can be designed in a similar way by further features and shows similar advantages. Such further features are exemplary, but not exhaustive, described in the subclaims following the independent claim.

The invention is also explained below with regard to further advantages and features by reference to the attached drawing using embodiments. The figures of the drawing show in:

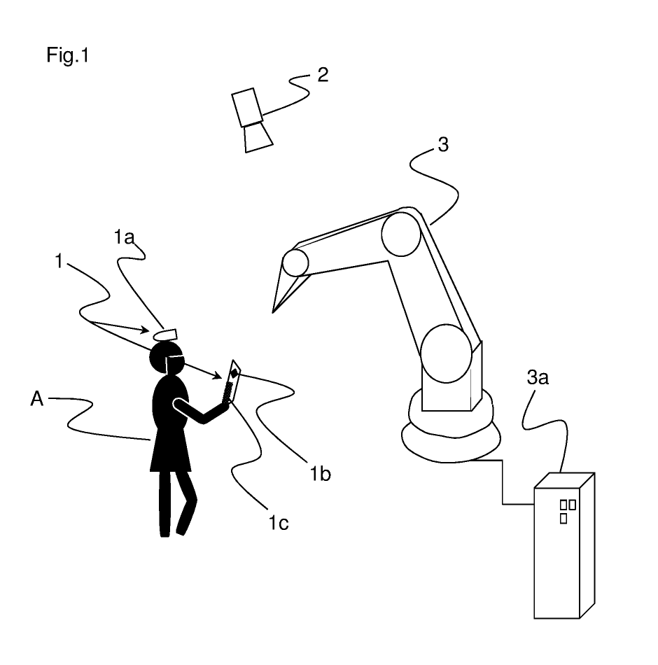

FIG. 1 a schematic illustration of a real environment in which the inventive augmented reality system is used; and

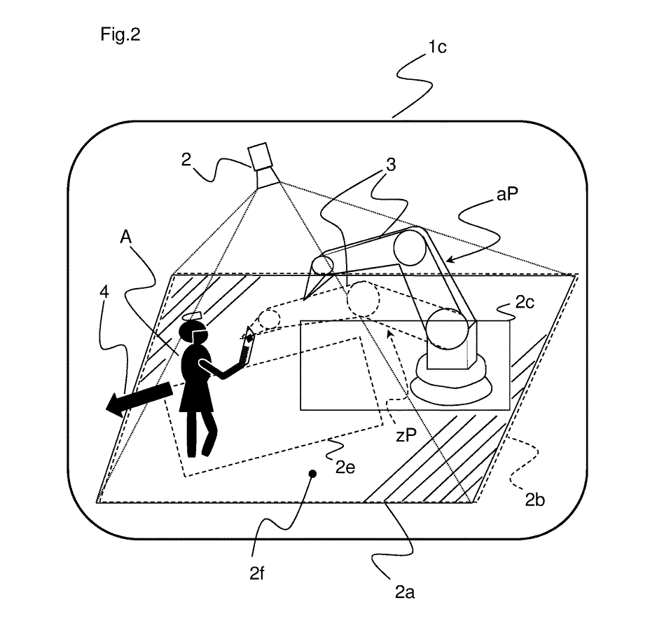

FIG. 2 the schematic detail illustration of a display unit of the augmented reality system according to the invention.

FIG. 1 shows a schematic illustration of an exemplary real environment in which a user A uses an augmented reality system 1 according to the invention, which in the following is referred to as AR system 1. In the environment, user A is in the vicinity of a working unit 3, which is shown in FIG. 1 as an example of an industrial robot. There may also be more working units 3 arranged or located in the vicinity. The working unit 3 is connected to a control 3a which controls the processes of the working unit. The controlled processes of the working unit 3 are stored as process data in the control unit 3a. The process data include in particular transaction data of working unit 3. CAD data of working unit 3 can also be provided in the process data, so that, for example, a true to scale image of working unit 3 can be displayed. Working unit 3 may also include a driverless transport system or other processing machine. In this context, transaction data means, for example, control data for controlling the robot or for driving the driverless transport system from A to B.

Furthermore, a monitoring unit 2 is arranged in the real environment, which monitors the real environment and in particular the working unit 3. Monitoring by monitoring unit 2 is carried out on the basis of safety data stored in monitoring unit 2. The safety data shall preferably include geometric data relating to a working area 2a and 2b of the monitoring unit 2 as shown in FIG. 2. The monitoring unit 2 may include a monitoring camera, in particular a room depth detecting camera, a scanner, a light grid or a light barrier. For the sake of convenience, the example shows a so-called 3D camera as the only monitoring unit 2.

The inventive AR system 1 used by user A comprises a detection unit 1a, which detects the real environment with working unit 3 and monitoring unit 2. The detection unit 1a provided the collected information as environmental data. The detection unit 1a preferably comprises a camera that detects a room depth and/or a wide-angle camera, so that the real environment is detected extensively and in detail. In this context, environmental data is understood as data from the camera that is available as image data or can be converted into image data.

Furthermore, the AR system 1 comprises a communication unit 1b which receives the safety data from the monitoring unit 2 and the process data from the working unit 3, in particular from the control 3a of the working unit 3. The AR system 1 also includes a control unit not shown in FIG. 1, which processes the environmental data, the safety data and the process data.

As shown in FIG. 2, the control unit uses the environmental and safety data to create a current working area 2a of monitoring unit 2 and a current position aP of working unit 3 as a current mapping of the real environment. The current mapping of the real environment is represented by solid lines.

Furthermore, the control unit creates a future working area 2b of the monitoring unit 2 and a future position zP of the working unit 3 as a virtual mapping on the basis of the safety data and the process data at a future point in time, whereby the future point in time may be advantageously selectable. The virtual mapping is represented by the dashed lines in FIG. 2. Furthermore, the control unit shown in FIG. 2 is integrated in the AR system 1. The control unit can also be arranged separately from the AR-System 1, so that the calculated mappings are transmitted to a display unit 1c.

The current mapping (solid lines) and the virtual mapping (dashed lines) are displayed in relation to each other to user A on the display unit 1c of the AR system 1, where an image of user A is displayed in the overlapping current and virtual mapping at the point in time the current mapping is created. When displaying the virtual mapping in the display unit 1c, an area between the current and the future position aP and zP can be additionally highlighted, for example shaded or colored, so that the user A can orient himself visually easier in the image.

In other words, on the display unit 1c of the AR device 1, the user A using the inventive AR system 1 can see the real environment, i.e. the image of himself, the monitoring unit 2 with its current working area 2a and the working unit 3 in its current position aP, and a future environment following at the point in time, i.e. the future working area 2b of the monitoring unit 2 and the future position zP of the working unit 3 at the future point in time. This enables user A to gain an insight into the process sequence of working unit 3 on the one hand and to avoid a possible collision with working areas 2a and 2b of monitoring unit 2 and with working unit 3 on the other.

Furthermore, it is advantageous that the display unit 1c shows a transition of the working unit 3 from the current position aP to the future position zP on the basis of the process data as a visual sequence of a movement of the working unit 3 to the user A. The visual sequence of the movement reproduces a movement path of the working unit 3, whereby the movement path is shown on the display unit 1c, for example in the form of semi-transparent images of the working unit 3 or in the form of a schematic tube. This results in the advantage that user A not only recognizes the current and future position aP and zP of working unit 3, but also clearly sees the trajectory of working unit 3 between these two positions aP and zP. This also allows user A to see if he may not be on a collision course with working unit 3 within a time window between the current mapping and the virtual mapping.

The future point in time can be selected as a point in time in several seconds of the future safety and process data, whereby in these seconds the current working area 2a of monitoring unit 2 has moved into a future position of the future working area 2b of monitoring unit 2, if the working area 2a of monitoring unit 2 should be changeable with a movement of working unit 3. In these seconds the current position aP of working unit 3 has moved to the future position zP of working unit 3 based on the process data. FIG. 2 shows the working unit 3 in the future position zP with dotted lines as a distinction to the working unit 3 in the current position aP. It is also possible to use another display type in the display unit 1c, such as the use of different colors or a full display of working unit 3 in the current position aP and a semi-transparent display of working unit 3 in the future position zP.

By the selectable future point in time between the used current and future security and process data, the user can set a sufficiently large time window for himself between the current mapping and the virtual future mapping, so that he can move safely in the environment.

Preferably, the working area 2a and 2b of the monitoring unit 2 is divided into a protective area 2c and 2e and into a monitoring area 2f, whereby detection of an impermissible object, such as user A, within protective areas 2c and 2e triggers a safety reaction of the monitoring unit 2 and the monitoring area 2f represents an entire visible area of the monitoring unit 2. If user A is in the monitoring area 2f, monitoring unit 2 can issue a warning reaction. A direct view of working unit 3 from user A is not necessary. Despite, for example, turning user A's back to working unit 3 in the real environment, user A can use the AR system 1 to see everything and capture the entire environment.

In other words, if user A is in the monitoring area 2f of monitoring unit 2, a warning and a deceleration of working unit 3 can occur as a reaction. If the user A is in the protective areas 2c and 2e, the working unit 3 would be shut down as a reaction. Since user A on the display unit 1c of the AR system 1 recognizes both the future working area 2b of monitoring unit 2 and the future position zP of working unit 3, user A can move more freely without the risk of a collision. Advantageously, potential collisions are indicated to user A by warning color in the AR system 1. This allows user A to receive both audible and visual warnings from AR System 1.

According to FIG. 2, the protective area 2c can be moved or changed with the movement of the working unit 3, so that the AR system 1 indicates to user A that user A is in the current mapping in the monitoring area 2f of the monitoring unit 2, but not in the protective area 2c of the monitoring unit 2. This allows a warning signal to be output or displayed to user A. However, the AR system 1 shows in the virtual mapping that working unit 3 will have moved from the current position aP to the future position zP after the future point in time and that the protective area 2c of monitoring unit 2 will also have moved from the current position to the new position of the future protective area 2e, so that user A must expect a possible collision with the working unit 3 on the one hand and on the other hand will be located in the future monitoring area 2e of the monitoring unit 2, so that working unit 3 would be switched off.

The AR system 1 can preferably calculate an avoidance direction 4 or an avoidance route for user A and display it in display unit 1c so that collision with the future position zP of working unit 3 and violation of the future monitoring area 2e of monitoring unit 2 can be safely avoided. In this case, the avoidance direction 4 or, advantageously, the avoidance route indicates or leads to a position which is outside the working area 2a and 2b of the monitoring unit 2 and/or the future position zP of the working unit 3. In this way, the AR-System 1 provides user A with a safe avoidance to protect user A from damage and avoid switching off working unit 3.

The AR system 1 preferably comprises a pair of glasses, a helmet display or an electronic communication device, wherein the communication device may be a smartphone or a touchpad. The AR-System 1 is therefore very handy and easy to use, so that user A has a high degree of freedom of movement with the AR-System 1.

Furthermore, the future working area 2b or the future protective area 2e of the monitoring unit 2 and the future position zP of the working unit 3 can be calculated by the control unit or transmitted from the monitoring unit 2 and from the control unit 3a of the working unit 3 to the communication unit 1b. Here the transmission can be carried out by radio.

### LIST OF REFERENCE SIGNS

1 Augmented reality system/AR system
1a detection unit
1b communication unit
1c display unit
2 monitoring unit
2a current working area
2b future working area
2c current protective area
2e future protective area
2f monitoring area
3 working unit
3a control unit
4 avoidance direction
A user
aP current position
zP future position

1. Augmented reality system for overlapping an augmented reality with a real environment, comprising
a detection unit which detects the real environment and provides it as environmental data, at least one monitoring unit and at least one working unit being arranged in the environment,
a communication unit receiving safety data from the monitoring unit and process data from the working unit,
a control unit which processes the environmental data, the safety data and the process data, wherein a current working area of the monitoring unit and a current position of the working unit are creatable on the basis of the environmental and safety data as a current mapping of the real environment, and wherein a future working area of the monitoring unit and a future position of the working unit are creatable as a virtual mapping on the basis of the safety and process data at a preferably selectable future point in time, and
a display unit that displays the current mapping and the virtual mapping to a user in relation to each other, wherein an image of the user is displayed in the overlapping current and virtual mapping at a current point in time of creation of the current mapping.

2. Augmented reality system according to claim 1, wherein the augmented reality system comprises a pair of glasses, a helmet display or an electronic communication device, in particular a smartphone or a touchpad.

3. Augmented reality system according to claim 1, wherein the detection unit comprises a camera, in particular a camera detecting a room depth, and/or wide-angle camera.

4. Augmented reality system according to claim 1, wherein the monitoring unit comprises a monitoring camera, in particular a monitoring camera detecting a room depth, a scanner, a light grid or a light barrier.

5. Augmented reality system according to claim 1, wherein the working unit comprises a robot, a driverless transport system or a processing machine.

6. Augmented reality system according to claim 1, wherein the future point in time lies in several seconds in the future after the current working area of the monitoring unit has moved into a future position of the working area of the monitoring unit, if the working area of the monitoring unit is changeable with a movement of the working unit.

7. Augmented reality system according to claim 6, wherein the current position of the working unit has moved into the future position of the working unit after the seconds on the basis of the process data.

8. Augmented reality system according to claim 1, wherein the future working area of the monitoring unit and the future position of the working unit are calculable by the control unit or transmitted from the monitoring unit and the control of the working unit to the control unit of the augmented reality system.

9. Augmented reality system according to claim 1, wherein the future working area of the monitoring unit represents a visual direction of the monitoring unit.

10. Augmented reality system according to claim 1, wherein an avoidance direction or an avoidance route for the user is calculable and displayable in order to avoid a collision with the future position of the working unit.

11. Augmented reality system according to claim 10, wherein the avoidance direction indicates a position or the avoidance route leads to a position, which lies outside the working area of the monitoring unit and/or the future position of the working unit.

12. Augmented reality system according to claim 1, wherein the safety data of the monitoring unit comprises geometric data of the working area and the process data of the working unit comprises transaction data of the working unit.

13. Augmented reality device according to claim 1, wherein the working area of the monitoring unit is subdivided into a protective area and a monitoring area, wherein a detection of an impermissible object within the protective area triggers a safety reaction of the monitoring unit and the monitoring area represents an entire visible area of the monitoring unit.

14. Augmented reality system according to claim 1, wherein a transition of the working unit from the current position to the future position on the basis of the process data is displayable as a visual sequence of the process data on the display unit.
